(19) United States
(12) Patent Application Publication
(10) Pub. No.: US 2024/0308495 A1
(43) Pub. Date: Sep. 19, 2024

(54) DERIVING AND VISUALIZING AN AMOUNT OF ACCELERATION AVAILABLE TO A VEHICLE

(71) Applicant: Dana Automotive Systems Group, LLC, Maumee, OH (US)

(72) Inventors: Peter DECKMYN, Koekelare (BE); Stijn GOOSSENS, Erpe-Mere (BE)

(21) Appl. No.: 18/184,435

(22) Filed: Mar. 15, 2023

(51) Int. Cl. B60W 20/10; B60W 10/06; B60W 10/08; B60W 50/14

(52) U.S. Cl. CPC B60W 20/10; B60W 10/06; B60W 10/08; B60W 50/14; B60W 2050/146; B60W 2510/06; B60W 2510/08; B60W 2510/1005; B60W 2520/10; B60W 2520/105; B60W 2530/10

(57) ABSTRACT

Systems and methods are shown for estimating an available amount of acceleration available to a vehicle. In one example, a method for a controller of a vehicle comprises displaying an estimated available acceleration of the vehicle at a current speed of the vehicle in an in-cabin display of the vehicle, the estimated available acceleration estimated based on a performance characteristic of a power source of the vehicle and a model of an interaction of the vehicle with an environment of the vehicle. The power source may include one or both of an internal combustion engine and an electric machine.

### TECHNICAL FIELD

The present disclosure relates to providing vehicle performance data to a driver of a vehicle.

### BACKGROUND AND SUMMARY

During operation of a vehicle, a driver of the vehicle may wish to increase a speed of the vehicle (e.g., to accelerate from a first speed to a second, higher speed). For example, a second vehicle may be operating on a road ahead of the vehicle, and the driver may wish to overtake the second vehicle. The driver may estimate an amount of power of the vehicle that is available for an acceleration to overtake the second vehicle. If the driver estimates that the amount of available power is sufficient, the driver may initiate the acceleration (e.g., by pressing an accelerator pedal of the vehicle). If the driver estimates that the amount of available power is not sufficient, the driver may not initiate the acceleration.

However, estimating the amount of available power for the acceleration may be complicated. The power consumed during the acceleration may vary according to factors such as the speed of the vehicle; driving conditions, such as a slope of the road the vehicle is operating on; a current power setpoint; a current gear of a transmission of the vehicle; and other factors. For example, when operating at higher speeds, the available power for acceleration may be less then at lower speeds.

The vehicle may include various gauges that indicate measurements such as vehicle speed, a number of revolutions per minute (RPM) of an internal combustion engine (ICE) of the vehicle, a pressure of a turbocharger of the vehicle, a state of charge of a battery of the vehicle, and the like. These gauges may aid the driver in making decisions regarding the operation of the vehicle. For example, an RPM gauge may be used by the driver to determine when to shift gears of a manual transmission.

However, the gauges may be of limited value in helping the driver estimate the amount of power available for the acceleration. In particular, if the vehicle is an automatic or hybrid electric vehicle, the current gear may not be known to the driver, and downshifts could increase the torque, depending on the speed. As a result, the driver may not be able to accurately determine whether the vehicle has sufficient power to perform the acceleration.

In one example, the issue described above may be addressed by a method for a controller of a vehicle, comprising displaying an estimated available acceleration of the vehicle at a current speed of the vehicle in an in-cabin display of the vehicle, the estimated available acceleration estimated based on a performance characteristic of a power source of the vehicle and a model of an interaction of the vehicle with an environment of the vehicle. The power source may include one or both of an internal combustion engine and an electric machine. The performance characteristic may indicate a performance of the power source at the current speed, which may be used to determine an amount of power consumed by the vehicle at the current speed. The amount of consumed power may be adjusted by the model, based on model parameters such as a mass and/or weight of the vehicle; a load of the vehicle; an inclination of the vehicle; a road condition of the vehicle, such as whether the road is paved, dusty, or wet; a condition of the environment, such as whether it is raining or snowing; and so on.

The available acceleration may be expressed as a percentage of a maximum amount of possible acceleration of the vehicle, where the percentage may be indicated in the in-cabin display via a bar, an analog metric with a needle, a series of bars, or in a different way. The driver may view the amount of available acceleration in relation to the maximum possible acceleration to determine whether the available acceleration is sufficient to perform the acceleration. If the driver assesses the amount of available acceleration as sufficient, the driver may initiate the acceleration. If the driver assesses the amount of available acceleration as insufficient, the driver may not initiate the acceleration. By not initiating the acceleration when the amount of available acceleration is assessed as insufficient, a wasted attempt at accelerating may be avoided, increasing a performance of the vehicle, and reducing an amount of fuel consumed by the vehicle and an amount of emissions of the vehicle released during the wasted attempt. Further, a confidence of the driver in operating the vehicle may be increased, leading to a more satisfactory driving experience.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

Various aspects of this disclosure may be better understood upon reading the following detailed description and upon reference to the drawings, in which:

FIG. 1 is a block diagram of a prophetic example of a vehicle;

FIG. 2 is a block diagram of a prophetic example controller of the vehicle, in accordance with one or more embodiments of the present disclosure;

FIG. 3 is block diagram showing a calculation of an amount of available acceleration of the vehicle, in accordance with one or more embodiments of the present disclosure;

FIG. 4 is a flowchart illustrating an exemplary method for calculating the amount of available acceleration, in accordance with one or more embodiments of the present disclosure;

FIG. 5 is a graph illustrating a maximum amount of power available for the acceleration of the vehicle as a function of a speed of the vehicle, in accordance with one or more embodiments of the present disclosure;

FIG. 6 is a graph illustrating an amount of power available for the acceleration of the vehicle as a function of a gear of a transmission of the vehicle, in accordance with one or more embodiments of the present disclosure;

FIG. 7A is a first prophetic example of a visual indicator of the amount of available acceleration, in accordance with one or more embodiments of the present disclosure;

FIG. 7B is a second prophetic example of a visual indicator of the amount of available acceleration, in accordance with one or more embodiments of the present disclosure;

FIG. 7C is a third prophetic example of a visual indicator of the amount of available acceleration, in accordance with one or more embodiments of the present disclosure; and

FIG. 8 is a fourth prophetic example of a visual indicator of the amount of available acceleration, in accordance with one or more embodiments of the present disclosure.

### DETAILED DESCRIPTION

Systems and methods are proposed herein for aiding a driver of a vehicle in estimating an amount of acceleration available to the vehicle, also referred to herein as an available acceleration. Specifically, a first set of methods are described for deriving the available acceleration, and second set of methods are described for displaying information regarding the available acceleration to the driver.

In current dashboard displays, no indication of the available acceleration at a current speed may be provided. As a result, the driver may estimate the available acceleration indirectly and mentally, by combining speedometer information, a number of rotations per minute (RPMs), and an estimated accelerator pedal position. However, a mental estimation of available acceleration may be inaccurate. If the driver is not able to accurately estimate the available acceleration, the driver may initiate an acceleration only to discover that the vehicle lacks sufficient power to achieve a desired result of the acceleration, such as overtaking a vehicle. In such situations, the driver may have to terminate the acceleration and reduce the speed of the vehicle, leading to a decreased performance of the vehicle, an inefficient use of fuel of the vehicle, increased emissions of the vehicle, and/or a less satisfactory driving experience.

To address this, the inventors herein propose to estimate the available acceleration of the vehicle based on a combination of existing offline information, such as motor data, vehicle data, and road characteristics, and online information, including speed and engine setpoint data. The calculated amount of available acceleration is then displayed to the driver in a user-friendly manner, via one or more proposed displays. The proposed solution may be applied in various driveline configurations (e.g., internal combustion engine (ICE), hybrid electric vehicle (HEV), electric vehicle (EV)). By consulting the one or more proposed displays, the driver may determine more accurately and confidently whether the vehicle has sufficient power to meet a desired acceleration.

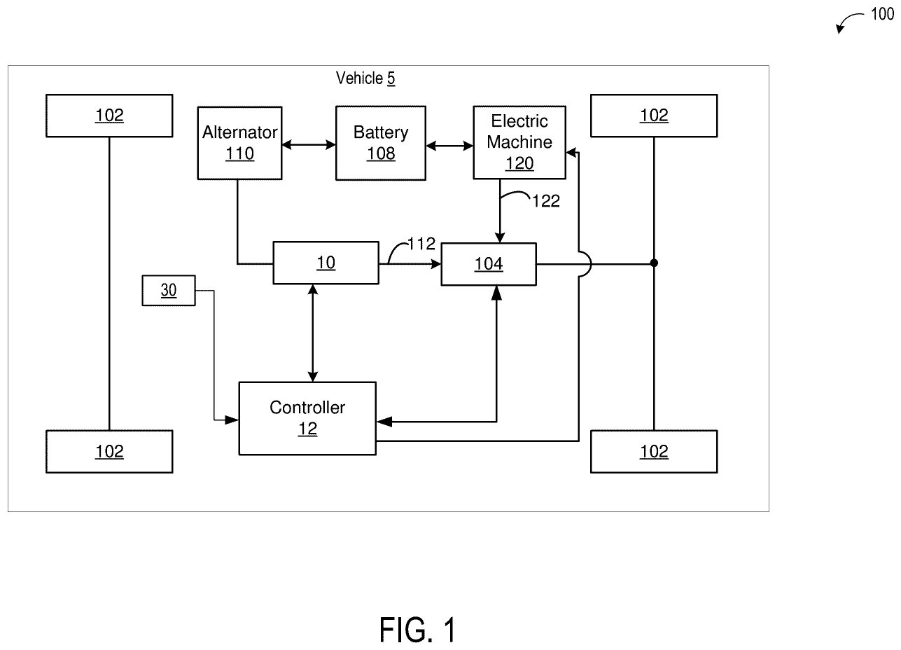

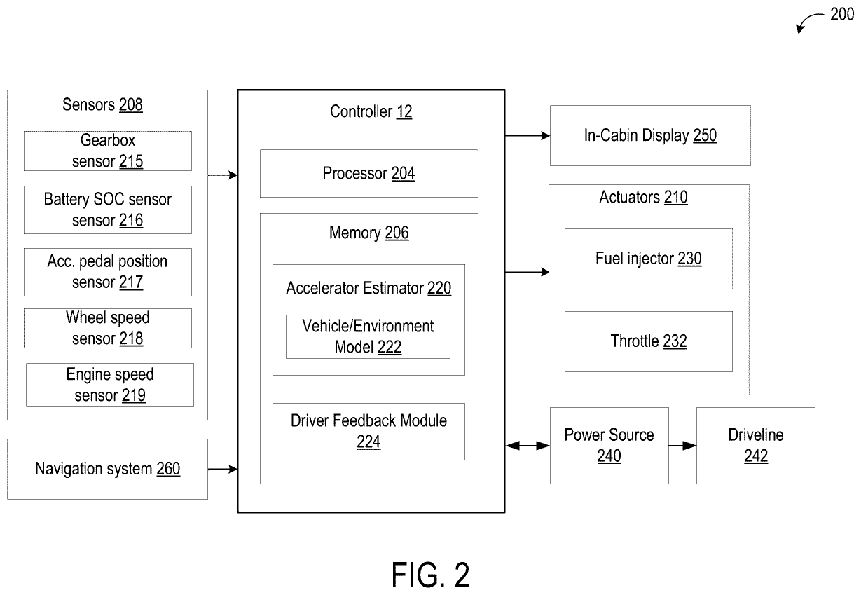

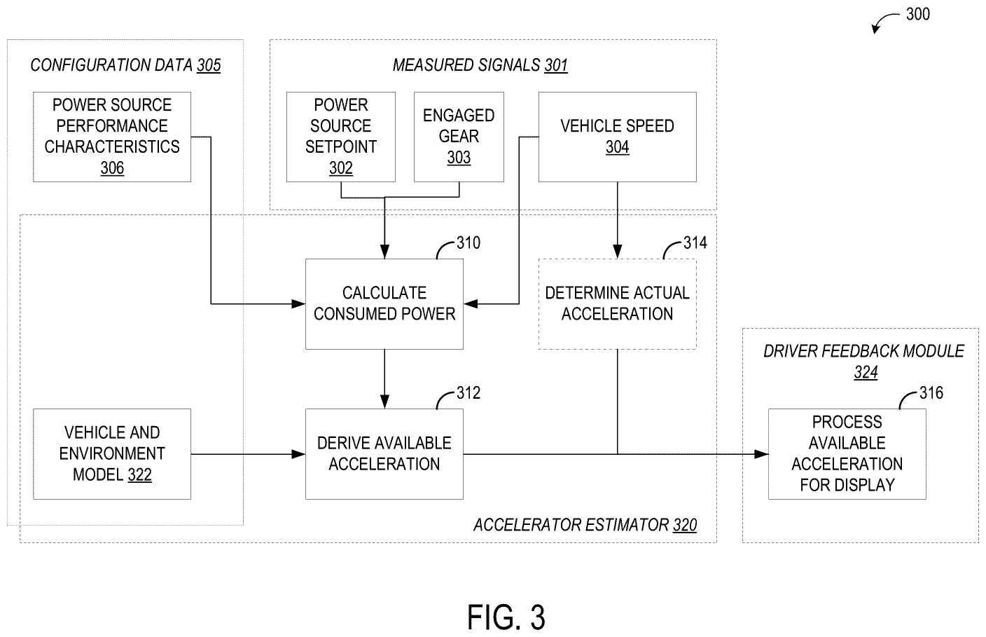

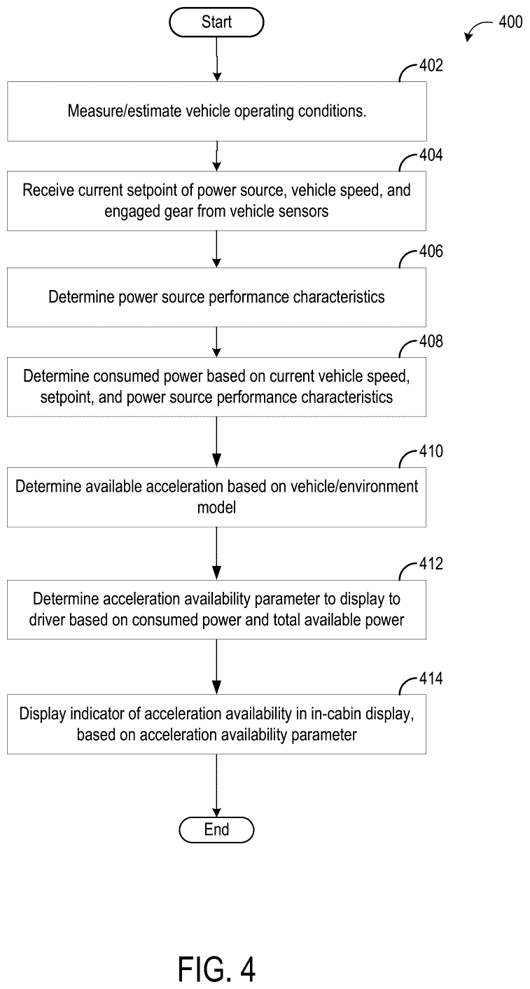

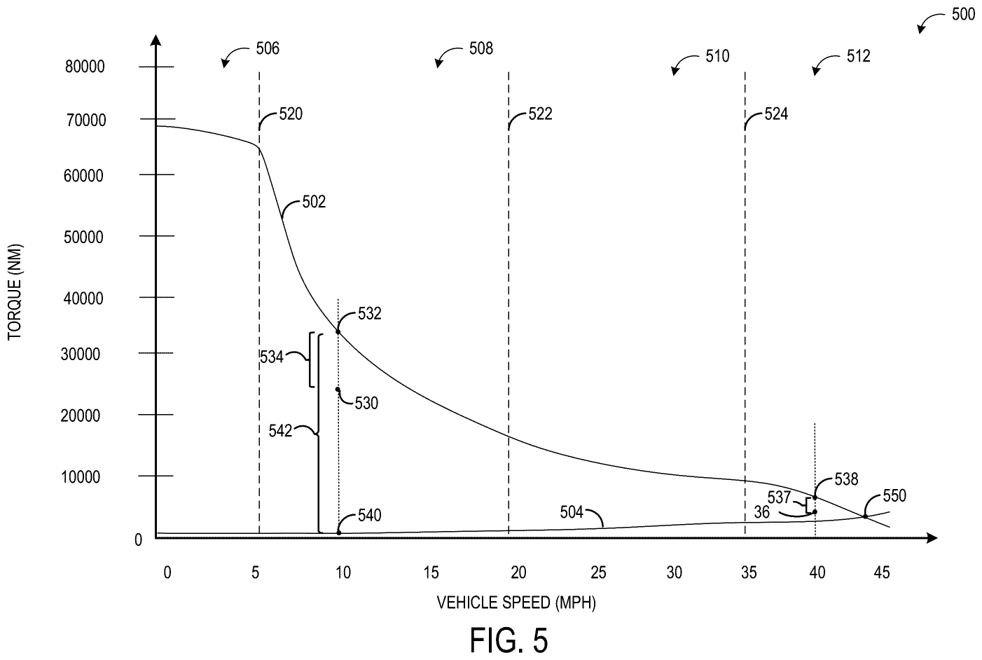

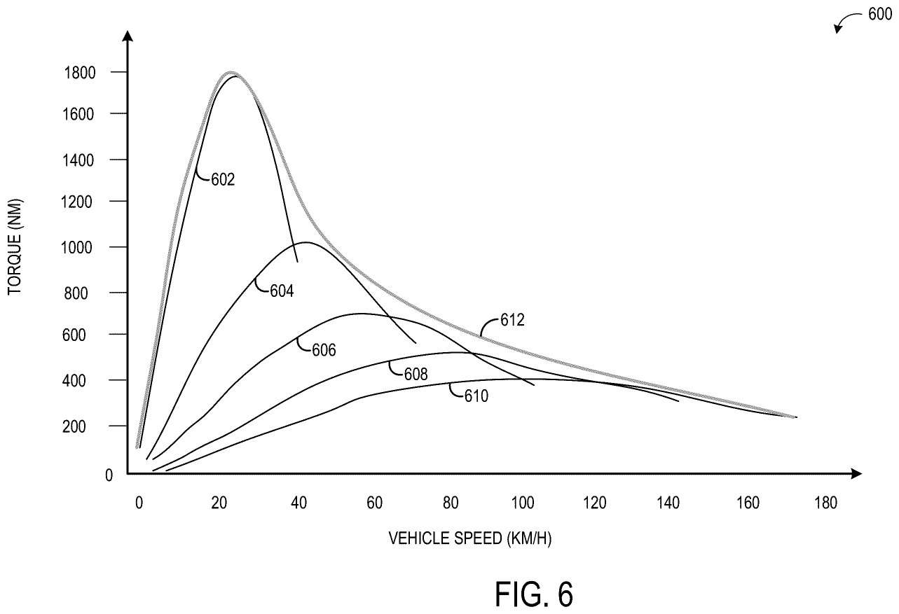

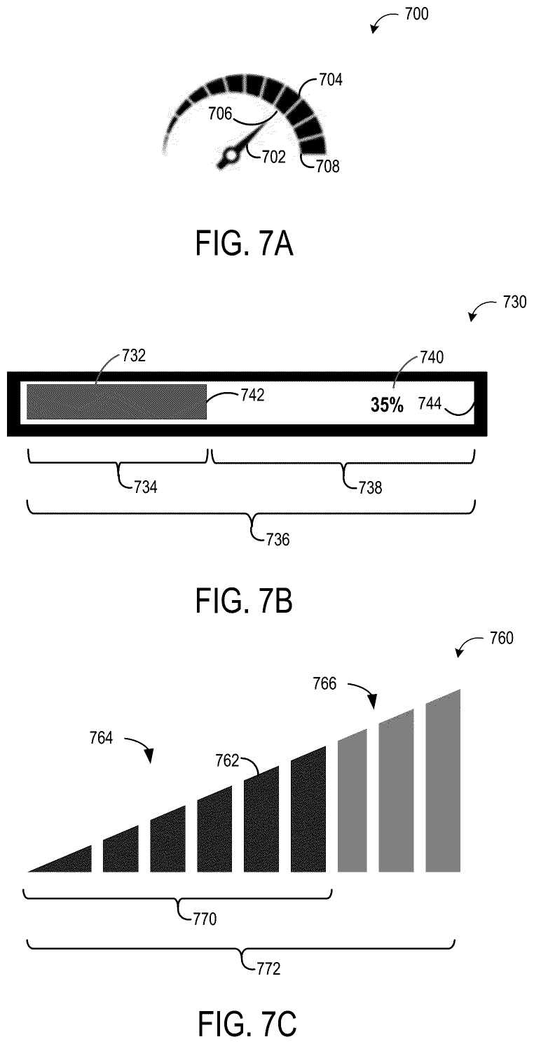

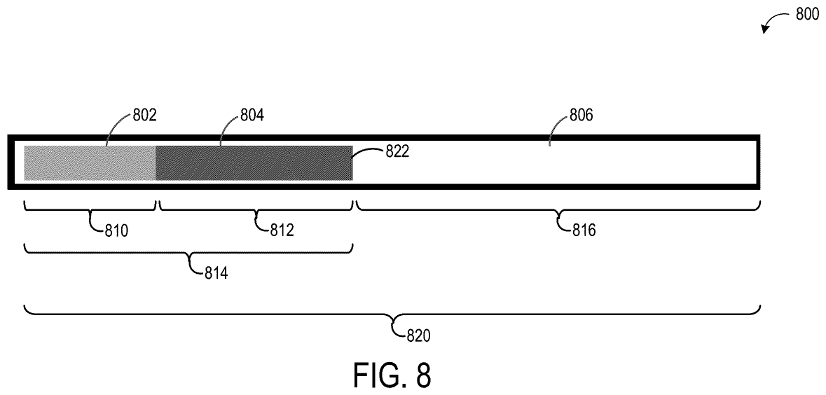

An example vehicle is shown in FIG. 1, including a controller shown in FIG. 2. The controller may calculate an amount of available acceleration of the vehicle based on outputs of various sensors and configuration data, as visually depicted in FIG. 3, by following one or more steps of the method shown in FIG. 4. Calculating the amount of available acceleration may include determining an amount of power available to the vehicle as a function of vehicle speed, in accordance with the graph shown in FIG. 5. Different amounts of power may be available depending on a engaged gear of a transmission of the vehicle, as shown in FIG. 6. The amount of available acceleration may be displayed on an in-cabin display of the vehicle via an indicator, such as the example indicators of FIGS. 7A, 7B, 7C, and 8.

Referring now to FIG. 1, an example vehicle 5 is shown. In various examples, vehicle 5 is a hybrid vehicle with multiple sources of torque available to one or more vehicle wheels 102. In other examples, vehicle 5 is a conventional vehicle with only an engine, or an electric vehicle with only electric machine(s). In the example shown, vehicle 5 includes an internal combustion engine 10 and an electric machine 120. Electric machine 120 may be a motor or a motor/generator. Electric machine 120 may be configured to utilize or consume a different energy source than engine 10. For example, engine 10 may consume a liquid fuel (e.g., gasoline) to produce an engine output while electric machine 120 may consume electrical energy to produce a motor output. As such, the vehicle 5 may be referred to as a hybrid electric vehicle (HEV).

In a non-limiting embodiment, electric machine 120 receives electrical power from a battery 108 to provide torque to vehicle wheels 102. Engine 10 and electric machine 120 are connected to the vehicle wheels 102 via a transmission 104. Transmission 104 may be a gearbox, a planetary gear system, or another type of transmission.

Vehicle 5 may utilize a variety of different operational modes depending on operating conditions encountered. Some of these modes may enable engine 10 to be maintained in an off state where combustion of fuel at the engine is discontinued. For example, under select operating conditions, electric machine 120 may propel the vehicle via transmission 104 as indicated by arrow 122 while engine 10 is deactivated. The select operating conditions may include a stopped condition, wherein the engine 10 may be maintained in an off state while the vehicle 5 is not moving. When the vehicle 5 begins to accelerate, the vehicle 5 may be propelled by electric machine 120, or engine 10 may be switched to an on state and may propel the vehicle 5.

During other operating conditions, electric machine 120 may be operated to charge an energy storage device such as the battery 108. For example, electric machine 120 may receive wheel torque from transmission 104 as indicated by arrow 122 where the motor may convert the kinetic energy of the vehicle to electrical energy for storage at battery 108. Thus, electric machine 120 may provide a generator function in some embodiments. However, in other embodiments, alternator 110 may instead receive wheel torque from transmission 104, or energy from engine 10, where the alternator 110 may convert the kinetic energy of the vehicle to electrical energy for storage at battery 108.

During still other operating conditions, engine 10 may be operated by combusting fuel received from a fuel system (not shown in FIG. 1). For example, engine 10 may be operated to propel the vehicle via transmission 104 as indicated by arrow 112 while electric machine 120 is deactivated. During other operating conditions, both engine 10 and electric machine 120 may each be operated to propel the vehicle via transmission 104 as indicated by arrows 112 and 122, respectively. A configuration where both the engine and the motor may selectively propel the vehicle may be referred to as a parallel type vehicle propulsion system. Note that in some embodiments, electric machine 120 may propel the vehicle via a first drive system and engine 10 may propel the vehicle via a second drive system.

Operation in the various modes described above may be controlled by a controller 12. During operation of vehicle 5, controller 12 may receive commands from a driver of vehicle 5. Controller 12 may receive a request for torque via an accelerator pedal 30, for example, when the driver wishes to accelerate the vehicle. The driver may initiate an acceleration of the vehicle by applying a pressure on accelerator pedal 30. Controller 12 may command engine 10 or electric machine 120 to supply the requested torque to perform the acceleration, based on a position of accelerator pedal 30. Controller 12 is described below in more detail in reference to FIG. 2.

Turning to FIG. 2, a schematic depiction 200 of controller 12 of vehicle 5 is shown. Controller 12 may include a processor 204. The processor 204 may generally include any number of microprocessors, ASICs, ICs, etc. The controller 12 may include a memory 206 (e.g., FLASH, ROM, RAM, EPROM and/or EEPROM) that stores instructions that may be executed to carry out one more control routines. As discussed herein, memory includes any non-transient computer readable medium in which programming instructions are stored. For the purposes of this disclosure, the term tangible computer readable medium is expressly defined to include any type of computer readable storage. The example methods and systems may be implemented using coded instruction (e.g., computer readable instructions) stored on a non-transient computer readable medium such as a flash memory, a read-only memory (ROM), a random-access memory (RAM), a cache, or any other storage media in which information is stored for any duration (e.g. for extended period time periods, permanently, brief instances, for temporarily buffering, and/or for caching of the information). Computer memory of computer readable storage mediums as referenced herein may include volatile and non-volatile or removable and non-removable media for a storage of electronic-formatted information such as computer readable program instructions or modules of computer readable program instructions, data, etc. that may be stand-alone or as part of a computing device. Examples of computer memory may include any other medium which can be used to store the desired electronic format of information and which can be accessed by the processor or processors or at least a portion of a computing device.

Controller 12 is shown receiving information from a plurality of sensors 208 and sending control signals to a plurality of actuators 210. Sensors 208 may include a gearbox sensor 215, which may indicate a selected (e.g., engaged) gear of a transmission of the vehicle (e.g., transmission 104). Sensors 208 may include a battery state of charge (SOC) sensor 216 that outputs a state of charge of battery 108. Sensors 208 may include an accelerator pedal position sensor 217, which may measure a position of accelerator pedal 30. As described above, the position of accelerator pedal 30 may be used to calculate a commanded acceleration of vehicle 5. Sensors 208 may additionally include a wheel speed sensor 218, which may measure a speed of vehicle 5, and an engine speed sensor 219, which may measure a rotational speed (e.g., a number of rotations per minute (RPM)) of engine 10. The accelerator pedal position, vehicle speed, and/or engine speed may be used by an algorithm for determining an available acceleration of the vehicle, as described in greater detail below. Sensors 208 may additionally include one or more of an exhaust gas sensor, an upstream and/or downstream temperature sensor, an airflow sensor, brake pedal position sensor, a pressure sensor, an air/fuel ratio (AFR) sensor, a catalyst temperature sensor, a composition sensor, and/or other sensors, which may be coupled to various locations in the vehicle 5.

Actuators 210 may include a fuel injector 230 and a throttle 232. In response to an increase in pressure on accelerator pedal 30, throttle 232 may be actuated to a more open position to increase an acceleration of vehicle 5. In response to a decrease in pressure on accelerator pedal 30, throttle 232 may be actuated to a more closed position to reduce an acceleration of vehicle 5. Similarly, fuel injector 230 may be actuated to adjust the AFR of vehicle 5 to increase the speed of vehicle 5. Actuators 210 may additionally include one or more other valves of engine 10 and/or a fuel system of vehicle 5, which may adjust a performance of engine 10 or a flow of fuel and/or exhaust gases in the fuel system. It should be appreciated that the examples provided herein are for illustrative purposes and other types of sensors and/or actuators may be included without departing from the scope of this disclosure.

In general, controller 12 receives input from vehicle sensors 208 that indicate engine, transmission, electrical and climate states, which are used in conjunction with a driver input (e.g., such as the accelerator pedal) to control an operation of vehicle 5. Controller 12 may receive input from a navigation system 260. Navigation system 260 may include an onboard global positioning system (GPS), and information accessed via navigation system 260 may be used to determine future operating conditions of vehicle 5. For example, route information of vehicle 5 may be accessed from navigation system 260, and based on the route information, an inclination of vehicle 5 and/or a gradient of a slope on which vehicle 5 is being operated may be estimated. The inclination and/or gradient may be used to determine an amount of power consumed in an acceleration of vehicle 5, as described in greater detail below.

The controller 12 may receive input data from the various sensors 208, process the input data, and trigger the actuators 210 in response to the processed input data based on instructions stored in the memory 206. For example, the controller 12 may receive input data from an air/fuel ratio sensor indicating that an air/fuel ratio of the engine is low, and as a result, the controller 12 may command a fuel injector to adjust the air/fuel ratio. In response to the input data, controller 12 may send commands to a power source 240 (e.g., engine 10, electric machine 120) to supply torque to a driveline 242 of the vehicle to propel the vehicle.

Memory 206 may include an accelerator estimator module 220, which may estimate an amount of power consumed during an acceleration of the vehicle and/or an amount of power available for accelerating the vehicle. Accelerator estimator module 220 may receive input from sensors 208, including battery SOC sensor 216, accelerator pedal position sensor 217, wheel speed sensor 218, and/or engine speed sensor 219. Accelerator estimator module 220 may include a vehicle/environment model 222, which may provide configuration data used to estimate an available acceleration of the vehicle based on the amount of power consumed during the acceleration of the vehicle. Estimating the available acceleration of the vehicle is described in greater detail below in reference to FIGS. 3 and 4. In particular, the amount of available acceleration may be estimated by following one or more steps of the method of FIG. 4.

Memory 206 may include a driver feedback module 224. Driver feedback module 224 may receive current power consumption data, current acceleration data, and/or available acceleration data outputted by the accelerator estimator module 220, and process and/or prepare the data to be displayed to the driver via an in-cabin display. Processing and/or preparing the data may include selecting one or more visual elements for visualizing the current power consumption data, current acceleration data, and/or available acceleration data. The processing and/or preparing of the data by driver feedback module 224 is described in greater detail below in reference to FIG. 3.

Referring now to FIG. 3, a block diagram 300 shows a flow of data during a calculation of a quantifiable amount of acceleration available to a vehicle for performing a desired acceleration. For example, a vehicle may wish to perform the desired acceleration to overtake a vehicle, or to achieve a target speed for entering traffic on a highway, or for a different reason. The amount of available acceleration may be calculated by a controller of the vehicle, such as controller 12 of vehicle 5 of FIGS. 1 and 2. In various embodiments, the amount of available acceleration may be calculated at an accelerator estimator module 320 of the controller, such as accelerator estimator module 220 of FIG. 2.

The available acceleration may be calculated by accelerator estimator module 320 based on one or more measured signals 301, and vehicle configuration data 305. Measured signals 301 may be outputs of sensors of the vehicle, such as sensors 208 described above in reference to FIG. 2. For example, measured signals 301 may include a measured vehicle speed 304, which may be measured by a wheel speed sensor such as wheel speed sensor 218 of FIG. 2. Measured signals 301 may include an indication of an engaged gear of a transmission of the vehicle, which may be indicated by a gearbox sensor such as gearbox sensor 215 of FIG. 2. Measured signals 301 may also include a power source setpoint 302, where the power source may be an ICE, an electric machine, or a combination of the ICE and the electric machine. For example, power source setpoint 302 may be a setpoint of an engine (e.g., engine 10) of the vehicle generated by the controller to control a performance of the engine during operation of the vehicle.

Vehicle configuration data 305 may include data characterizing a performance of the power source at different speeds, based on a type of the vehicle and/or power source. In some embodiments, the data may be included in one or more reference (e.g., lookup) tables stored in a memory of the controller (e.g., memory 206). Vehicle configuration data 305 may also include a vehicle and environment model 322, which may characterize the performance of the vehicle under different vehicle and/or environmental conditions. For example, the performance of the vehicle may vary depending on a type of road (e.g., paved, unpaved, etc.), an amount of dirt, water, snow, or other elements on the road, a mass or weight of the vehicle, a load of the vehicle, a degree of inclination of the vehicle and/or grade of the road, and so on. Vehicle and environment model 322 may be generated based on a vehicle dynamics study. In one embodiment, a vehicle speed (e.g., vehicle speed 304) and a torque may be inputted into vehicle and environment model 322, and vehicle and environment model 322 may output an estimated acceleration that may be obtained by the vehicle speed when the torque is applied. Vehicle and environment model 322 may determine the acceleration based on internal constants, such as a front surface of the vehicle, a type of wheels of the vehicle, an estimated weight of the vehicle, and the like. In another embodiment, a more complex vehicle and environment model 322 could take additional inputs, such as an an actual inclination of the vehicle. In various embodiments, vehicle and environment model 322 could be a rules-based system (e.g., implemented as a lookup table), or a machine learning model, or a statistical model, or a different type of model.

Accelerator estimator 320 may receive power source setpoint 302 and vehicle speed 304, and, at a first processing block 310, calculate an amount of power consumed by the vehicle based on power source setpoint 302 and vehicle speed 304. To perform the calculation, power source setpoint 302 and vehicle speed 304 may be used to retrieve one or more performance characteristics 306 of the power source(s) from configuration data 305. The one or more performance characteristics 306 may include data regarding an amount of power that the power source may be able to produce at vehicle speed 304, given power source setpoint 302. For example, the amount of power that the power source may be able to produce under different circumstances may depend on limitations imposed during a manufacturing of the vehicle. As another example, the power source may include an electric motor of the vehicle, and the amount of power that the power source may be able to produce may depend on current limits of the power source. The current limits may specify, for example, an amount of time over which a desired amount of power may be taken from a battery of the vehicle. If a predicted duration of an acceleration is longer than the amount of time, the desired amount of power may not be available.

In various embodiments, the one or more performance characteristics 306 may be retrieved from the one or more reference tables based on power source setpoint 302, vehicle speed 304, and/or other data available at the controller. Outputs of first processing block 310 may include an estimated maximum amount of power available to the vehicle; an estimated total possible amount of power available to the vehicle, which may be less than the maximum amount of power; an actual amount of power being consumed by the vehicle at the time of receiving setpoint 302 and vehicle speed 304; and/or an estimated remaining amount of power that may be applied to the desired acceleration.

At a second processing block 312, accelerator estimator 320 derives a level of acceleration that the vehicle can achieve based on the available amount of power for acceleration derived by processing block 310 and an output of vehicle and environment model 322. The vehicle and environment model may take into consideration a load of the vehicle, or a slope of a road the vehicle is travelling on, or current weather conditions, or other factors, to obtain the derived level of acceleration. In various embodiments, an output of second processing block 312 may be an estimated amount of acceleration available to the vehicle based on the specific vehicle and/or environmental conditions at the time, for example, in meters per second squared (m/s²).

At a third, optional processing block 314, an actual (e.g., current) acceleration of the vehicle at the time may be calculated based, for example, on a change of vehicle speed 304 over a preceding duration.

The available acceleration of the vehicle and the actual acceleration may be inputs into a fourth processing block 316. In some embodiments, the processing at fourth processing block 316 may be performed at or by a driver feedback module 324 of the controller (e.g., driver feedback module 224 of FIG. 2). In other embodiments, the processing at fourth processing block 316 may be performed at or by accelerator estimator 320. In still other embodiments, the processing at fourth processing block 316 may be performed at or by a different controller or ECU of the vehicle.

At fourth processing block 316, the actual acceleration (obtained at processing block 314) may be combined with the available acceleration (obtained at processing block 312) and scaled to a set of figures suitable to display to the driver, as described below, or to be used by another vehicle system. The available acceleration may be displayed to the driver, for example, via an in-cabin display such as a dashboard display. The available acceleration may be displayed via an acceleration availability indicator, such as the example acceleration availability indicators shown in FIGS. 7A, 7B, 7C, and 8.

The processing performed at first processing block 310, second processing block 312, third processing block 314, and fourth processing block 316 may be performed based on the method of FIG. 4, described below.

Referring now to FIG. 4, an exemplary method 400 is shown for calculating an amount of available acceleration of a vehicle, and displaying the available acceleration to a driver of the vehicle. For the purposes of this disclosure, the acceleration refers to a positive acceleration of the vehicle, from a first, lower speed to a second, higher speed. The vehicle may be a non-limiting example of vehicle 5 of FIG. 1.

In various embodiments, method 400 may be performed by a controller of the vehicle, such as controller 12 of vehicle 5 described in reference to FIG. 2. In other embodiments, some or all of the steps of method 400 may be performed by a different controller than controller 12. For example, in some embodiments, one or more steps of method 400 may be performed by a first electronic control unit (ECU) of the vehicle (e.g., controller 12), and one or more steps of method 400 may be performed by a separate ECU. For example, in one embodiment, one or more steps of method 400 may be performed by a first processor (e.g., processor 204) based on instructions stored in an accelerator estimator module (e.g., accelerator estimator module 220) of a memory of the first ECU. In another embodiment, the first ECU may not include the accelerator estimator module, and the one or more steps of method 400 may be performed by a processor of the separate ECU, based on instructions stored in an accelerator estimator module of a memory of the separate ECU. Similarly, one or more steps of method 400 may be performed based on instructions stored in a driver feedback module of a memory of either or both of the first ECU or the separate ECU.

Method 400 begins at 402, where method 400 includes estimating and/or measuring vehicle operating conditions. Vehicle operating conditions may be estimated based on one or more outputs of various sensors of the vehicle (e.g., such as an oil temperature sensor, engine velocity or wheel velocity sensor, exhaust gas sensor, battery SOC sensor, etc., as described above in reference to vehicle 5 of FIG. 1 and controller 12 of FIG. 2. Vehicle operating conditions may include engine velocity and load, vehicle velocity, oil temperature, exhaust gas flow rate, coolant temperature, coolant flow rate, electric motor velocity, battery charge, engine torque output, vehicle wheel torque, etc.

At 404, method 400 includes receiving a current speed of the vehicle, an indication of an engaged gear of the vehicle, and a current setpoint of a power source of the vehicle. The current speed of the vehicle (e.g., vehicle speed 304 of FIG. 3) may be measured based on a number of revolutions of a wheel of the vehicle, which may be measured by a wheel speed sensor, such as wheel speed sensor 218 of FIG. 2. In some embodiments, the current speed of the vehicle may be received from an automatic braking system (ABS) controller of the vehicle. The engaged gear of the vehicle may be determined by a gearbox sensor, such as gearbox sensor 215 of FIG. 2.

The current setpoint of the power source (e.g., power source setpoint 302) may be identical to a setpoint established by the controller. For example, the current setpoint may be an engine setpoint of a throttle of an ICE of the vehicle (e.g., throttle 232 of engine 10), or a torque setpoint of an inverter/electric motor of the vehicle (e.g., electric machine 120), or the current setpoint may be based on both the engine setpoint and the torque setpoint. In other embodiments, the current setpoint may be based on a measurement of a consumed electric power, a torque measurement, and/or a speed of the electric motor.

At 406, method 400 includes determining one or more performance characteristics of the power source relating to an acceleration of the vehicle (e.g., power source performance characteristics 306 of FIG. 3). The power source performance characteristics may include a theoretical maximum amount of torque or power that the power source can provide based on the current speed and/or favored gear of the vehicle at the current speed. The power source performance characteristic may be based on characteristics of an ICE, gearbox, and/or electric motor of the vehicle. For example, for a vehicle with an ICE, a first amount of power may be provided by the ICE as a function of speed and an engaged gear of the vehicle. For a hybrid vehicle including an electric motor, a second amount of power may be provided by the electric motor as a function of speed and the engaged gear of the vehicle. For a hybrid vehicle including both the ICE and the electric motor, a third amount of power may be provided as a function of speed and current gear, where the third amount of power is provided by a combination of the ICE and electric motor.

For vehicles with an electric motor, the power source performance characteristics may include a maximum amount of torque that can be generated from the electric motor within a given duration, due to current limitations. For example, a first amount of power may be applied to the electric motor during a first duration. To apply a second, larger amount of power to the electric motor, a second, longer duration may be used, where the second, larger amount of power may not be applied within the first duration. As a result, a performance characteristic of the electric motor may include an amount of available power of the electric motor over a predetermined duration (e.g., a duration of an average acceleration).

In various embodiments, the power source performance characteristics may be retrieved from one or more reference tables stored in a memory of the controller (e.g., memory 206) based on the current speed of the vehicle, engaged gear of the vehicle, and setpoint of the power source. Values stored in the one or more reference tables may be obtained based on various functions, such as the functions graphed in FIGS. 5 and 6.

Referring briefly to FIG. 5, a first example power graph 500 shows a theoretical amount of power (e.g., torque) available to a vehicle, such as vehicle 5 of FIG. 1, as a function of a speed of the vehicle. The theoretical amount of power available to the vehicle may be used for an acceleration of the vehicle.

First example power graph 500 includes a first line 502 indicating a maximum amount of power available at one or more wheels of the vehicle as a function of vehicle speed, and a second line 504 indicating a reference amount of power that the vehicle may use to maintain a cruising speed. Maintaining the cruising speed may mean maintaining the speed of the vehicle at a constant speed, without positive or negative accelerations. In various embodiments, the maximum amount of power available at the one or more wheels may depend on a configuration of a power source of the vehicle.

Line 502 may be divided into four portions by a first dashed line 520, a second dashed line 522, and a third dashed line 524. During a first portion 506 of line 502, corresponding to vehicle speeds under five miles an hour, the maximum amount of power available at the one or more wheels may be high. During a second portion 508 of line 502, corresponding to vehicle speeds between five miles an hour and 20 miles an hour, the maximum amount of power available at the one or more wheels may decrease rapidly. During a third portion 510 of line 502, corresponding to vehicle speeds between 20 and 35 miles an hour, the maximum amount of power available at the one or more wheels decreases slowly. During a fourth portion 512 of line 502, corresponding to vehicle speeds above 35 miles an hour, the maximum amount of power available at the one or more wheels may decrease at a faster rate than at vehicle speeds between 20 and 35 miles an hour. Thus, at lower vehicle speeds, the maximum amount of available power for acceleration may be generally high, and as the speed of the vehicle increases, less power is available for acceleration, with a lowest maximum amount of power available for acceleration above speeds of 45 miles an hour.

An actual (e.g., current) amount of consumed power at a given speed may be lower than the maximum available power indicated by line 502. The actual consumed power may correspond to a setpoint of the power source, which for a vehicle speed indicated on the X axis of graph 500 may be between zero and a point on line 502 representing the maximum available power at the vehicle speed. For example, a first setpoint 530 on graph 500 may indicate an actual amount of power consumed by the vehicle at a speed of 10 miles per hour, which may be less than a maximum amount of power available to the vehicle at a first maximum point 532 of graph 500. Thus, a first possible amount of power/torque available for accelerating the vehicle at 10 mph may be represented by a first power difference 534 between first setpoint 530 and first maximum point 532. For example, the first possible amount of available power for accelerating the vehicle at 10 mph may be 10,000 Nm.

In contrast, a second setpoint 536 on graph 500 may indicate an actual amount of power consumed by the vehicle at a speed of 40 miles per hour, which may be less than a maximum amount of power available to the vehicle at a second maximum point 538 of graph 500. A second possible amount of power/torque available for accelerating the vehicle at 40 mph may be represented by a second power difference 537 between second setpoint 536 and second maximum point 538. For example, the second possible amount of available power for accelerating the vehicle at 40 mph may be 2,000 Nm. As can be seen in a comparison of first power difference 534 and second power difference 537, the possible amount of power available for accelerating the vehicle is greater at 10 mph than at 40 mph.

The possible amount of power available for an acceleration may be different from an actual amount of acceleration that may generated from the possible amount of power. Determining the available acceleration may include taking into consideration the power source performance characteristics and the output of the vehicle and environment model. In other words, a position of first setpoint 530 in graph 500 may be an input into a vehicle and environment model to determine the available acceleration.

Additionally, an amount of torque relied on for maintaining the vehicle at a given speed may be taken into consideration. In other words, calculating the available acceleration for the given speed may include calculating both the difference between the actual setpoint and the maximum amount of power available to the vehicle at the given speed, and a difference between the maximum amount of power available to the vehicle at the given speed and the amount of torque relied on for maintaining the vehicle at the given speed, which is indicated by line 504. For example, a point 540 on line 504 indicates the amount of torque relied on for maintaining the vehicle at 10 mph. A difference 542 is shown between the maximum amount of power available to the vehicle at 10 mph indicated by first maximum point 532, and the amount of torque relied on for maintaining the vehicle at 10 mph indicated by point 540. Difference 542 may represent a total amount of power available to the vehicle for an acceleration. Difference 534 and difference 542 may be used to determine an acceleration availability parameter to display to the driver, as described in greater detail below.

Further, the amount of available power for acceleration may depend on a current gear of a transmission of the vehicle. During first portion 506 of graph 500, the vehicle may be in first gear, which may generate a high amount of torque at the one or more wheels of the vehicle. During second portion 508, the vehicle may be in second gear, where a relatively high amount of torque may be generated as the vehicle switches from first gear to second gear, and the amount of torque generated may decrease rapidly as the vehicle accelerates. During third portion 510, the vehicle may be in third gear, which may a generate relatively low amount of torque in comparison to first and second gears. During fourth portion 512, the vehicle may be in fourth gear, where fourth gear may be able to provide a low and decreasing amount of torque. At a point 540 where line 502 intersects with line 504, sufficient torque may not be available to the vehicle to increase the speed of the vehicle above the cruising speed.

FIG. 6 shows a second example power graph 600 indicating a maximum amount of power available for accelerating a vehicle, as a function of a speed of the vehicle, for a plurality of different gears of the vehicle, where the vehicle may be the same as or similar to vehicle 5 of FIG. 1. A series of lines reflect typical performance curves of a manual/automatic 5 gear vehicle driveline in kilometers per hour, in contrast to FIG. 5, which depicts a pure electric driveline for a heavy vehicle (without gears) in miles per hour. Second example power graph 500 includes a first line 602 indicating a maximum amount of power available at one or more wheels of the vehicle for accelerating the vehicle in a first gear of the vehicle; a second line 604 indicating a maximum amount of available power in a second gear of the vehicle; a third line 606 indicating a maximum amount of available power in a third gear of the vehicle; a fourth line 608 indicating a maximum amount of available power in a fourth gear of the vehicle; and a fifth line 610 indicating a maximum amount of available power in a fifth gear of the vehicle. As described above in reference to FIG. 5, the maximum available power is highest in the first gear, with each successive gear providing a reduced maximum amount of available power. One will also notice that at a given speed, sufficient torque can be obtained in a certain gear, however the most available torque is obtained in a lower gear (commonly referred as downshifting). A sixth line 612 shows an approximation of the maximum available power across the first, second, third, fourth, and fifth gears, where the approximation has a similar shape as line 502 of first example power graph 500 of FIG. 5.

At 408, method 400 includes determining an amount of power being consumed by the vehicle based on factors including the measured current vehicle speed, the engaged gear, the setpoint, and the retrieved power source performance characteristics. In various embodiments, the power being consumed by the vehicle may be determined by an algorithm based on a rules-based system, which may apply various rules to the factors to calculate the amount of consumed power. In some embodiments, the various rules may be created manually by human experts. In some embodiments, the power being consumed by the vehicle may be determined using one or more reference tables, where the reference tables may be stored in the memory of the controller. In still other embodiments, the consumed power may be determined by a model, such as a statistical model.

It should be appreciated that the examples described herein are for illustrative purposes, and the amount of power being consumed by the vehicle may be determined or calculated in various different ways or by using various methods and/or models in conjunction, without departing from the scope of this disclosure.

At 410, method 400 includes determining an amount of acceleration available to the driver based on the amount of power being consumed, a maximum amount of power available to the vehicle, and an effect of a difference between the two based on vehicle dynamics. As described above, the amount of available acceleration may be determined based on an output of a vehicle and environment model (e.g., vehicle and environment model 322 of FIG. 3). The vehicle and environment model may take as input various measurable vehicle parameters, such as a size or dimensions of the vehicle, a weight and load of the vehicle, a driveline reduction and wheel diameter of the vehicle, and the like. The vehicle and environment model may also take as input data of an environment of the vehicle, for example, from sensors of the vehicle (e.g., sensors 208) such as temperature sensors, ABS sensors, one or more external cameras of the vehicle, and the like. The environmental data may include road surface data, such as whether a road on which the vehicle is being operated is paved or unpaved, a type of pavement of the road, and amount of dirt, dust, snow, or water on the road, and so on. The environmental data may include a slope of the road and/or an inclination of the vehicle. In some embodiments, the inclination of the vehicle may be inferred based on topographical and/or route data of the vehicle retrieved from a navigation system of the vehicle (e.g., navigation system 260). The vehicle/environment model may include data on an amount of air friction on the vehicle as a function of speed. The vehicle/environment model may take the vehicle parameters as inputs, and output the estimated available acceleration of the vehicle under the current vehicle and environmental conditions. The estimated available acceleration may be a value indicating an estimated change in the velocity of the vehicle over an amount of time, measured, for example, in m/s² or feet/s²). The amount of time used for the calculation may be the time in between two or more samples of the measured velocity. For example, for a sampling time of 20 milliseconds, the amount of time used may be 100 milliseconds. The vehicle/environment model may be a simple model based on simplified vehicle and environment parameters (e.g., standard road friction, flat road, vehicle weight, vehicle frontal dimension, etc.). Alternatively, the vehicle/environment model may be a complex model, which may be based at least partly on the simple model, and may be augmented with actual measured or estimated vehicle weight, vehicle inclination, etc. based on live vehicle monitoring.

For example, the vehicle may be travelling at 10 miles per hour, and the driver may wish to overtake a leading vehicle travelling at the same speed. The accelerator estimator module may first calculate a maximum amount of power available for use by the vehicle at 10 mph. The maximum amount of power available may be 35,000 Nm, as indicated by point 532 of FIG. 5. The 35,000 Nm and the 10 mph may be inputted into the vehicle/environment model. The vehicle/environment model may estimate an amount of acceleration that may be derived from the maximum amount of available power, based on characteristics of the vehicle and/or environment (e.g., weight, size, physical characteristics, climate, etc.). For example, the amount of acceleration that be derived from the maximum amount of available power based on characteristics of the vehicle and/or environment (e.g., the available acceleration) may be 5 m/s². The available acceleration may then be converted to a meaningful parameter for displaying to the driver, as described below.

At 412, method 400 includes determining an acceleration availability parameter to display to the driver, where the acceleration availability parameter indicates the estimated available acceleration of the vehicle. The acceleration availability parameter may be a value to feed to a display module (e.g., driver feedback module 224 and/or driver feedback module 324) that generates a visual indicator indicating an amount of acceleration available to the driver, based on the current speed. In some embodiments, the acceleration availability parameter V may be calculated based on the following equation:

V=(M−T)/M (1)

where T is the amount of available acceleration calculated at 410, and M is a maximum possible amount of acceleration calculated based on a second difference between a maximum power available for acceleration and an amount of torque relied on to maintain the vehicle at a current speed. For example, the rules-based model may calculate a difference in power between an actual setpoint (e.g., first setpoint 530), and a maximum available power of the power source (e.g., distance 542) derived from the retrieved power source performance characteristics. For vehicles including a gearbox, the engaged gear may be taken into account to derive the maximum available power.

In various embodiments, V may be expressed as a percentage. For example, V may be 20%, indicating that 20% of the maximum possible acceleration is available for the vehicle to use. Alternatively, V may be 80%, indicating that 80% of the maximum possible acceleration is currently available for the vehicle to use.

At 414, method 400 includes displaying a visual indicator showing a representation of the acceleration availability parameter in an in-cabin display of the vehicle, such as in-cabin display 250. In various embodiments, the in-cabin display is a dashboard display. The indicator may include physical components, such as dedicated LED lights, or graphic components in a computerized display on a screen of the in-cabin display, or a combination of physical and graphic components. For example, the visual indicator may be a gauge.

FIGS. 7A, 7B, and 7C show examples of different types of visual indicators that may be displayed in an in-cabin display of a vehicle such as vehicle 5 of FIG. 1 to represent an amount of power available to perform an acceleration of the vehicle.

FIG. 7A shows a first example indicator 700, where first example indicator 700 includes a graphic of an analog meter (e.g., a gauge) including a needle 702 and a plurality of rotationally aligned bars 704. In some embodiments, size of each bar of the plurality of rotationally aligned bars 704 may vary, to indicate a progression from a lower amount of available acceleration to a higher amount of available acceleration. In other embodiments, indicator 700, needle 702, and/or bars 704 may have different shapes or sizes. In some embodiments, numbers (e.g., percentages) may be indicated at one or more of the bars 704.

Needle 702 may point to a position 706 indicating an available acceleration of the vehicle in comparison to a maximum amount of available acceleration, where a position of needle 702 may depend on an acceleration availability parameter calculated by a controller of the vehicle (e.g., controller 12). In various embodiments, the acceleration availability parameter may be calculated by performing one or more steps of method 400 described above. As a speed of the vehicle increases, the actual power consumed by the vehicle may increase relative to the total amount of available power, due to the maximum amount of available power decreasing as a function of the speed of the vehicle (e.g., in accordance with a decreasing maximum amount of available power). Therefore, as the vehicle increases speed, needle 702 may rotate in a counter-clockwise direction to indicate a lower amount of available acceleration. Thus, by viewing indicator 700 prior to initiating an acceleration, a driver of the vehicle may estimate an amount of power available for the acceleration based on the position of the needle. Specifically, the amount of power available for the acceleration may be estimated based on a distance between position 706 and a maximum needle position 708. In FIG. 7A, the distance between position 706 and maximum needle position 708 may be small relative to a full range of needle 702, where the available acceleration may be high. In response to the available acceleration being high, the driver may decide to initiate the acceleration.

In some embodiments, colors, levels of illumination, or other visual features may be used to indicate relationships between the actual acceleration, available acceleration, and maximum acceleration. For example, a first color or illumination of a first portion of bars 704 may indicate a current acceleration; a second color or illumination of a second portion of bars 704 may indicate the available acceleration; and a third color or illumination of a third portion of bars 704 may indicate the maximum possible acceleration.

In some embodiments, a display of the amount of available acceleration in FIGS. 7A, 7B, and 7C may be adjusted or determined partly based on a predicted confidence level, where the predicted confidence level is a predicted degree of confidence that the estimate of availability of power is accurate. For example, if the predicted confidence level is greater than one or more threshold levels, one or more corresponding adjustments to the display may be made. For example, in FIG. 7A, a first color or illumination of needle 702, rotationally aligned bars 704, a background of indicator 700, or a different component of indicator 700, may be used to indicate a higher predicted confidence level, and a second color, illumination, etc. may be used to indicate a lower predicted confidence level.

The predicted confidence level may be predicted based on the power source performance characteristics, the speed of the vehicle, the setpoint of the power source, and/or other factors. In some examples, the vehicle and environment model may output the amount of available power as a first output, and may output the predicted confidence level as a second output. In other embodiments, the predicted confidence level may be predicted based on an output of a separate predictive model, such as a machine learning and/or neural network model. For example, the separate predictive model may take the power source performance characteristics, the speed of the vehicle, the setpoint of the power source, and an output of the vehicle and environment model as input, and output the predicted confidence level based on the power source performance characteristics, the speed of the vehicle, the setpoint of the power source, and the output of the vehicle and environment model.

FIG. 7B shows a second example indicator 730. Second example indicator 730 includes a bar 732 (e.g., a progress bar), where bar 732 may indicate the available acceleration of the vehicle (at a current speed) relative to the maximum amount of available acceleration. Bar 732 may have a first length 734, where a first ratio of first length 734 to a maximum length 736 of bar 732 may indicate the available acceleration relative to the maximum amount of available acceleration. A difference between first length 734 and maximum length 736 may indicate the acceleration available to the driver. Specifically, a distance between an end 742 of bar 732 and an end 744 of indicator 730 may have a second length 738, where the available acceleration may be indicated by a second ratio of a second length 738 to a maximum length 736 (e.g., an amount of remaining power). Thus, the driver may estimate the amount of available acceleration based on a relative size of first length 734 and/or second length 738. In some embodiments, the amount of available acceleration may be indicated by a text label 740. In FIG. 7B, the available acceleration is low, whereby the driver may decide not to initiate the acceleration.

FIG. 7C shows a third example indicator 760. Third example indicator 760 includes a plurality of vertically aligned bars 762. The size of each vertically aligned bar 762 may vary, to indicate a progression from a lower available acceleration of the vehicle to a higher available acceleration of the vehicle, in proportion to the maximum amount of available acceleration. In other embodiments, indicator 760 and/or vertically aligned bars 762 may have different shapes or sizes. In some embodiments, numbers (e.g., percentages) may be indicated at one or more of the vertically aligned bars 762.

In third example indicator 760, a first portion 764 of vertically aligned bars 762 is visually distinguished from a second portion 766 of vertically aligned bars 762. For example, first portion 764 of vertically aligned bars 762 may be illuminated, and a second portion 766 of vertically aligned bars 762 may not be illuminated, or first portion 764 of vertically aligned bars 762 may have a first color, and a second portion 766 of vertically aligned bars 762 may have a second color. In other embodiments, a different number of illuminated and/or colored portions may be used. For example, a gradient of colors may be used across vertically aligned bars 762 of first portion 764, where a color of each vertically aligned bar is progressively brighter. A first length 770 of first portion 764 may indicate the available acceleration of the vehicle, and a second length 772 may indicate the maximum available acceleration. In FIG. 7C, the available acceleration is high (e.g., 70%), whereby the driver may decide to initiate the acceleration.

FIG. 8 shows a fourth example indicator 800. Fourth example indicator 800 may be similar to second example indicator 730. Fourth example indicator 800 includes a first bar 802 (e.g., a progress bar), where bar 802 indicates an actual acceleration of the vehicle (at a current speed). First bar 802 may have a first length 810. Fourth example indicator 800 includes a second bar 804, where bar 804 indicates an amount of available acceleration of the vehicle (at a current speed). Second bar 804 may have a second length 812. First bar 802 may have a first color, and second bar 804 may have a second color. A total amount of available acceleration may comprise both bars 802 and 804, with a total length 814. Thus, a first ratio of first length 810 to total length 814 may indicate the actual acceleration relative to the total amount of available acceleration. Fourth example indicator 800 may have a length 820 that corresponds to a theoretical maximum amount of available acceleration (e.g., as described above in relation to line 502 of FIG. 5). In other words, fourth example indicator 800 may include a space 806 corresponding to a gap 816 between the total amount of available acceleration and the maximum amount of available acceleration. For example, the maximum amount of available acceleration may correspond to a situation where the speed of the vehicle is close to 0 and the vehicle is in first gear. As the vehicle gains speed and/or changes gear, the maximum amount of available acceleration becomes unobtainable.

Using indicator 800, the driver may estimate the amount of available acceleration by comparing a size of second length 812 to length 820. The available acceleration indicated by second length 812 may approach zero near a maximum vehicle speed. The current acceleration indicated by first length 810 may approach the value of available acceleration (e.g., at a point 822) to the extent that the accelerator pedal is pressed by the driver. Thus, second length 812 may be proportional to an amount of acceleration power available at any given moment.

As an example of how the acceleration availability may be used during operation of the vehicle, the driver may be driving the vehicle on a road behind a leading vehicle. The driver may wish to accelerate to overtake the leading vehicle. In preparation for overtaking the leading vehicle, the driver may view a dashboard indicator of the acceleration availability, which may be one of the example indicators shown in FIGS. 7A, 7B, 7C, or 8.

A controller of the vehicle may determine an amount of power being consumed by the vehicle, and an amount of power available to be used to accelerate the vehicle, in accordance with method 400 of FIG. 4. An accelerator estimator of the controller may determine a setpoint of a power source of the vehicle (an engine and/or an electric motor of the vehicle), and a speed of the vehicle from one or more sensors of the vehicle. The accelerator estimator may retrieve relevant performance characteristics of the power source from a reference table stored in a memory of the controller, based on the setpoint and vehicle speed. The setpoint, speed, and/or relevant performance characteristics may be inputted into a vehicle and environment model of the accelerator estimator, which may output an estimate of an amount of available acceleration in reference to a total and/or maximum available acceleration. A parameter quantifying the amount of available acceleration as a percentage of total and/or maximum available acceleration may be calculated at a driver feedback module of the controller. Based on the quantifying parameter, the driver feedback module may display the available acceleration in the dashboard indicator.

The driver may view the available acceleration indicator to estimate whether the amount of available power of the vehicle is sufficient to pass the leading vehicle. In a first driving scenario, the road the driver is following the leading vehicle on is flat, and the speed of the vehicle is 30 mph. The vehicle and environment model of the accelerator estimator may output a first amount of available acceleration of the vehicle based on the flat road and the vehicle speed. The available acceleration indicator may indicate that the first available acceleration is roughly a third of the total acceleration available to the vehicle to overtake the leading vehicle. For example, the available acceleration indicator may display a colored bar with a length that extends roughly 30% of a distance to a point representing the maximum acceleration available to the vehicle. As a result of seeing that the available acceleration is roughly a third of the total amount of available acceleration of the vehicle, the driver may determine that the available acceleration is not sufficient to overtake the leading vehicle, and may not pass the leading vehicle.

In a second driving scenario, the driver is following the leading vehicle up a hill with a grade, and the speed of the vehicle is 30 mph. An inclination of the vehicle based on the grade may be determined by the controller, based on topographical data retrieved from a GPS system of an onboard navigation system. The vehicle and environment model of the accelerator estimator may output a second available acceleration of the vehicle based on the inclination and the vehicle speed. The available acceleration indicator may indicate that the second amount of available acceleration constitutes roughly 80% of the maximum available acceleration of the vehicle to overtake the leading vehicle. For example, the colored bar of the available acceleration indicator may extend roughly 80% of the distance to the point representing the maximum available acceleration of the vehicle. As a result of seeing that the available acceleration is roughly 80% of the maximum available acceleration, the driver may determine that the available acceleration is sufficient to overtake the leading vehicle, and may then pass the leading vehicle.

In a vehicle not including the available acceleration indicator, the driver would have to mentally estimate whether the desired acceleration is feasible based on vehicle speed and environmental conditions. If the driver estimates poorly, the driver may attempt the desired acceleration, and may not achieve a target speed for achieving an operational goal, such as overtaking another vehicle. As a result of not achieving the target speed, the driver may abandon the attempted acceleration, and may not achieve the operational goal. As a result of the abandoned acceleration, a performance of the vehicle may be decreased, an amount of fuel spent on the acceleration may be wasted, and an amount of emissions of the vehicle may be greater than desired.

Alternatively, by consulting the available acceleration indicator, the driver may make a more informed decision about an expected performance of the vehicle during the desired acceleration. By consulting the available acceleration indicator prior to performing the desired acceleration of the vehicle, the driver may perform the desired acceleration with a higher probability of achieving the operational goal when the operational goal is achievable, and may decide not to perform the desired acceleration when the operational goal has a higher probability of not being achievable. As a result, the performance of the vehicle may increase or may be maintained at a desired level, an efficiency of a usage of fuel and a release of emissions of the vehicle may be increased, and a driving experience of the driver may be more satisfactory.

The technical effect of calculating and providing an indication to a driver of a vehicle of an amount of power available for performing an acceleration of the vehicle, is that a performance and efficiency of an operation of the vehicle may be increased.

The disclosure also provides support for a method for a controller of a vehicle, comprising: displaying an estimated amount of available acceleration of the vehicle at a current speed of the vehicle in an in-cabin display of the vehicle, the estimated available acceleration estimated based on a performance characteristic of a power source of the vehicle and a model of an interaction of the vehicle with an environment of the vehicle. In a first example of the method, the power source is at least one of an internal combustion engine of the vehicle and an electric motor of the vehicle. In a second example of the method, optionally including the first example, estimating the amount of available acceleration based on the performance characteristic and the model further comprises: receiving a setpoint of the power source, receiving a vehicle speed from a sensor of the vehicle, receiving a selected gear of the vehicle, retrieving the performance characteristic from a reference table stored in a memory of the controller based on the setpoint, the vehicle speed, and the selected gear, calculating an amount of power consumed by the vehicle at the current speed based on the setpoint, the vehicle speed, the selected gear, and the performance characteristic, calculating a total amount of available power of the vehicle based on the calculated amount of power consumed by the vehicle, calculating the available acceleration of the vehicle based on inputting the total amount of available power of the vehicle into the model, calculating a maximum amount of available acceleration of the vehicle, and calculating an acceleration availability parameter indicating the amount of available acceleration and the maximum amount of available acceleration. In a third example of the method, optionally including one or both of the first and second examples, the method further comprises: calculating the total amount of available power of the vehicle by subtracting an amount of power relied on by the vehicle to maintain the vehicle at the current speed from a maximum amount of available power of the vehicle, wherein the amount of power relied on by the vehicle to maintain the vehicle at the current speed and the maximum amount of available power of the vehicle are retrieved from one or more reference tables stored in a memory of the controller. In a fourth example of the method, optionally including one or more or each of the first through third examples, calculating the available acceleration of the vehicle based on inputting the calculated amount of power consumed by the vehicle into the model further comprises additionally inputting into the model at least one of: an inclination of the vehicle, a load of the vehicle, a mass of the vehicle, a detected condition of a road on which the vehicle is being operated, and a detected condition of the environment of the vehicle, and receiving the available acceleration as an output of the model. In a fifth example of the method, optionally including one or more or each of the first through fourth examples, the acceleration availability parameter is a percentage indicating the amount of available acceleration of the vehicle as a proportion of the maximum amount of available acceleration. In a sixth example of the method, optionally including one or more or each of the first through fifth examples, displaying the estimated available acceleration at the current speed in the in-cabin display of the vehicle further comprises displaying the acceleration availability parameter. In a seventh example of the method, optionally including one or more or each of the first through sixth examples, displaying the estimated available acceleration at the current speed further comprises displaying a bar, where the amount of available acceleration is indicated by a length of the bar, and the maximum amount of available acceleration is indicated by a maximum length of the bar. In a eighth example of the method, optionally including one or more or each of the first through seventh examples, displaying the estimated available acceleration at the current speed further comprises displaying an analog meter, where the amount of available acceleration is indicated by a position of a needle of the analog meter. In a ninth example of the method, optionally including one or more or each of the first through eighth examples, displaying the estimated available acceleration at the current speed further comprises displaying a plurality of vertically aligned bars, where the amount of available acceleration is indicated by a color or an illumination of a portion of the plurality of vertically aligned bars.

The disclosure also provides support for a system of a vehicle, comprising: a power source including one or both of an internal combustion engine and an electric machine, a controller including a processor and instructions stored in a memory of the controller that when executed, cause the controller to: receive a speed of the vehicle from a wheel speed sensor of the vehicle, based on the received speed, determine a total amount of power of the power source available to the vehicle, based on the received speed, a setpoint of the power source, and an engaged gear of a transmission of the vehicle, estimate an amount of power consumed by the vehicle at the received speed, determine an acceleration availability parameter based on the estimated amount of power consumed by the vehicle and the total amount of available power of the vehicle, the acceleration availability parameter indicating an amount of acceleration available to the vehicle, display a visual indication of the acceleration availability parameter in an in-cabin display of the vehicle. In a first example of the system, the total amount of available power of the power source available to the vehicle is determined by subtracting an amount of power used to maintain the vehicle at the received speed from a maximum amount of available power of the vehicle, the amount of power used to maintain the vehicle at the received speed and the maximum amount of available power retrieved from one or more reference tables stored in the memory of the controller. In a second example of the system, optionally including the first example, the amount of power consumed by the vehicle at the received speed is estimated based partly on a performance characteristic of the power source determined based on the received speed, the setpoint, and the selected gear. In a third example of the system, optionally including one or both of the first and second examples, the amount of acceleration available to the vehicle at the received speed is estimated based partly on an output of a model stored in the memory of the controller, the model taking as input the estimated amount of power consumed by the vehicle, one or more characteristics of the vehicle, and/or one or more characteristics of an environment of the vehicle. In a fourth example of the system, optionally including one or more or each of the first through third examples, the acceleration availability parameter is a percentage indicating the estimated amount of acceleration available to the vehicle as a proportion of a maximum amount of available acceleration of the vehicle. In a fifth example of the system, optionally including one or more or each of the first through fourth examples, the visual indication of the acceleration availability parameter includes one of: an analog meter including a needle, where the percentage is indicated by a position of the needle, a bar, where the percentage is indicated by a length of the bar, a plurality of bars, where the percentage is indicated by an illuminated portion of the plurality of bars.

The disclosure also provides support for a method for indicating an amount of power of a vehicle available for performing an acceleration of the vehicle to a driver of the vehicle, the method comprising: measuring a speed of the vehicle, determining a setpoint of a power source of the vehicle, determining an engaged gear of the vehicle, determining a performance characteristic of the power source, based on the speed, setpoint, and engaged gear, calculating an amount of power consumed by the vehicle based on the speed, setpoint, engaged gear, and performance characteristic, estimating a total amount of power available to the vehicle based on the amount of power consumed by the vehicle, a maximum amount of power available to the vehicle, and an amount of power used to maintain the vehicle at the speed, determining an amount of acceleration available to the vehicle based on an output of a model, the model taking as input the estimated total amount of power available to the vehicle, and displaying the amount of acceleration available to the vehicle on an in-cabin display of the vehicle. In a first example of the method, determining the amount of acceleration available to the vehicle based on an output of a model further comprises: inputting the estimated total amount of power available to the vehicle into the model, and receiving as an output of the model the amount of acceleration available to the vehicle, the amount of available acceleration based on at least one of: an inclination of the vehicle, a load of the vehicle, a mass of the vehicle, a detected condition of a road on which the vehicle is being operated, and a detected condition of the environment of the vehicle. In a second example of the method, optionally including the first example, the maximum amount of power available to the vehicle is predefined for the vehicle as a function of the speed of the vehicle. In a third example of the method, optionally including one or both of the first and second examples,: while operating the vehicle on a flat road in a first driving scenario, the driver views a first amount of available acceleration on an in-cabin display of the vehicle, and in response to the driver estimating that the first amount of available acceleration is sufficient to perform a desired acceleration, the driver performs the desired acceleration, and while operating the vehicle on a slope in a second driving scenario, the driver views a second amount of available acceleration on the in-cabin display, and in response to the driver estimating that the second amount of available acceleration is not sufficient to perform the desired acceleration, the driver does not perform the desired acceleration.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive.

It will be appreciated that the configurations and routines disclosed herein are exemplary in nature, and that these specific embodiments are not to be considered in a limiting sense, because numerous variations are possible. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A method for a controller of a vehicle, comprising:
displaying an estimated amount of available acceleration of the vehicle at a current speed of the vehicle in an in-cabin display of the vehicle, the estimated available acceleration estimated based on a performance characteristic of a power source of the vehicle and a model of an interaction of the vehicle with an environment of the vehicle.

2. The method of claim 1, wherein the power source is at least one of an internal combustion engine of the vehicle and an electric motor of the vehicle.

3. The method of claim 1, wherein estimating the amount of available acceleration based on the performance characteristic and the model further comprises:
receiving a setpoint of the power source;
receiving a vehicle speed from a sensor of the vehicle;
receiving a selected gear of the vehicle;
retrieving the performance characteristic from a reference table stored in a memory of the controller based on the setpoint, the vehicle speed, and the selected gear;
calculating an amount of power consumed by the vehicle at the current speed based on the setpoint, the vehicle speed, the selected gear, and the performance characteristic;
calculating a total amount of available power of the vehicle based on the calculated amount of power consumed by the vehicle;
calculating the available acceleration of the vehicle based on inputting the total amount of available power of the vehicle into the model;
calculating a maximum amount of available acceleration of the vehicle; and
calculating an acceleration availability parameter indicating the amount of available acceleration and the maximum amount of available acceleration.

4. The method of claim 3, further comprising calculating the total amount of available power of the vehicle by subtracting an amount of power relied on by the vehicle to maintain the vehicle at the current speed from a maximum amount of available power of the vehicle, wherein the amount of power relied on by the vehicle to maintain the vehicle at the current speed and the maximum amount of available power of the vehicle are retrieved from one or more reference tables stored in a memory of the controller.

5. The method of claim 3, wherein calculating the available acceleration of the vehicle based on inputting the calculated amount of power consumed by the vehicle into the model further comprises additionally inputting into the model at least one of:
an inclination of the vehicle;
a load of the vehicle;
a mass of the vehicle;
a detected condition of a road on which the vehicle is being operated; and
a detected condition of the environment of the vehicle; and
receiving the available acceleration as an output of the model.

6. The method of claim 3, wherein the acceleration availability parameter is a percentage indicating the amount of available acceleration of the vehicle as a proportion of the maximum amount of available acceleration.

7. The method of claim 6, wherein displaying the estimated available acceleration at the current speed in the in-cabin display of the vehicle further comprises displaying the acceleration availability parameter.

8. The method of claim 6, wherein displaying the estimated available acceleration at the current speed further comprises displaying a bar, where the amount of available acceleration is indicated by a length of the bar, and the maximum amount of available acceleration is indicated by a maximum length of the bar.

9. The method of claim 6, wherein displaying the estimated available acceleration at the current speed further comprises displaying an analog meter, where the amount of available acceleration is indicated by a position of a needle of the analog meter.

10. The method of claim 6, wherein displaying the estimated available acceleration at the current speed further comprises displaying a plurality of vertically aligned bars, where the amount of available acceleration is indicated by a color or an illumination of a portion of the plurality of vertically aligned bars.

11. A system of a vehicle, comprising:
a power source including one or both of an internal combustion engine and an electric machine;
a controller including a processor and instructions stored in a memory of the controller that when executed, cause the controller to:
receive a speed of the vehicle from a wheel speed sensor of the vehicle;
based on the received speed, determine a total amount of power of the power source available to the vehicle;
based on the received speed, a setpoint of the power source, and an engaged gear of a transmission of the vehicle, estimate an amount of power consumed by the vehicle at the received speed;
determine an acceleration availability parameter based on the estimated amount of power consumed by the vehicle and the total amount of available power of the vehicle, the acceleration availability parameter indicating an amount of acceleration available to the vehicle;
display a visual indication of the acceleration availability parameter in an in-cabin display of the vehicle.

12. The system of claim 11, wherein the total amount of available power of the power source available to the vehicle is determined by subtracting an amount of power used to maintain the vehicle at the received speed from a maximum amount of available power of the vehicle, the amount of power used to maintain the vehicle at the received speed and the maximum amount of available power retrieved from one or more reference tables stored in the memory of the controller.

13. The system of claim 11, wherein the amount of power consumed by the vehicle at the received speed is estimated based partly on a performance characteristic of the power source determined based on the received speed, the setpoint, and the selected gear.

14. The system of claim 11, wherein the amount of acceleration available to the vehicle at the received speed is estimated based partly on an output of a model stored in the memory of the controller, the model taking as input the total amount of available power, one or more characteristics of the vehicle, and/or one or more characteristics of an environment of the vehicle.

15. The system of claim 11, wherein the acceleration availability parameter is a percentage indicating the estimated amount of acceleration available to the vehicle as a proportion of a maximum amount of available acceleration of the vehicle.

16. The system of claim 15, wherein the visual indication of the acceleration availability parameter includes one of:
an analog meter including a needle, where the percentage is indicated by a position of the needle;
a bar, where the percentage is indicated by a length of the bar;
a plurality of bars, where the percentage is indicated by an illuminated portion of the plurality of bars.

17. A method for indicating an amount of power of a vehicle available for performing an acceleration of the vehicle to a driver of the vehicle, the method comprising:
measuring a speed of the vehicle;
determining a setpoint of a power source of the vehicle;
determining an engaged gear of the vehicle;
determining a performance characteristic of the power source, based on the speed, setpoint, and engaged gear;
calculating an amount of power consumed by the vehicle based on the speed, setpoint, engaged gear, and performance characteristic;
estimating a total amount of power available to the vehicle based on the amount of power consumed by the vehicle, a maximum amount of power available to the vehicle, and an amount of power used to maintain the vehicle at the speed;
determining an amount of acceleration available to the vehicle based on an output of a model, the model taking as input the estimated total amount of power available to the vehicle; and
displaying the amount of acceleration available to the vehicle on an in-cabin display of the vehicle.

18. The method of claim 17, wherein determining the amount of acceleration available to the vehicle based on the output of the model further comprises:
inputting the estimated total amount of power available to the vehicle into the model, and receiving as an output of the model the amount of acceleration available to the vehicle, the amount of available acceleration based on at least one of:
an inclination of the vehicle;
a load of the vehicle;
a mass of the vehicle;
a detected condition of a road on which the vehicle is being operated; and
a detected condition of the environment of the vehicle.

19. The method of claim 17, wherein the maximum amount of power available to the vehicle is predefined for the vehicle as a function of the speed of the vehicle.

20. The method of claim 17, wherein:
while operating the vehicle on a flat road in a first driving scenario, the driver views a first amount of available acceleration on an in-cabin display of the vehicle, and in response to the driver estimating that the first amount of available acceleration is sufficient to perform a desired acceleration, the driver performs the desired acceleration; and
while operating the vehicle on a slope in a second driving scenario, the driver views a second amount of available acceleration on the in-cabin display, and in response to the driver estimating that the second amount of available acceleration is not sufficient to perform the desired acceleration, the driver does not perform the desired acceleration.
